(19) United States
(12) Patent Application Publication
(10) Pub. No.: US 2015/0287040 A1
(43) Pub. Date: Oct. 8, 2015

(54) SYSTEM ENFORCED TWO-PARTY VERIFICATION PROCESS IN CUSTOMER SUPPORT WORKFLOW

(71) Applicant: Microsoft Corporation, Redmond, WA (US)

(72) Inventors: KANGRONG YAN, Bellevue, WA (US); RAJEEV RAJAN, Kirkland, WA (US); PRETISH ABRAHAM, Sammamish, WA (US)

(73) Assignee: Microsoft Corporation, Redmond, WA (US)

(21) Appl. No.: 14/243,401

(22) Filed: Apr. 2, 2014

(51) Int. Cl. G06Q 30/00

(52) U.S. Cl. CPC G06Q 30/016

(57) ABSTRACT

A system-enforced two party verification process is described. An action to be taken on a resource is permitted when that resource is tagged with a same code by both a service vendor and the customer to whom the resource is associated. The system issues the code to the service vendor and relies on the service vendor to provide the code to the customer. The system then permits the action to be taken on the resource or automatically causes the action to be taken upon receipt of the code being applied by the customer to the same resource as previously indicated by the service vendor.

### BACKGROUND

In software service customer support, there are risky operations that customers may request the software service vendor to perform. For example, a customer may call the service vendor to de-provision an unused subscription. However, errors may arise in the support process because the customer and service vendor are typically not sitting physically side by side, may not be communicating in real-time, and the service vendor workflow may involve a multiple tiered workflow (involving multiple tiers of support staff). These errors can include acting on the wrong customer account or on the wrong resources within the customer's account by mistake, causing service outage or data loss.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and processes are described that enable a software service vendor and customer to mutually verify and act on a customer resource so that the wrong resource and/or wrong customer account is not acted upon in error.

As part of a system enforced two-party verification process, an action can be permitted to be taken on a resource (such as a subscription or other service) when the system determines that a specific resource of a particular customer is associated (e.g., “tagged”) with a same code by both the service vendor and the particular customer.

The system may issue a first code in response to receiving a vendor's indication of performing an action upon a specific resource. Once issued, this first code is stored associated with the specific resource of a particular customer (e.g., the resource is “tagged” with the first code). The service vendor initiates the process to issue the first code. According to certain implementations, the service vendor—not the system—communicates the first code to the customer. In many cases, the code may be output to the service vendor while the service vendor is accessing the system and the service vendor emails, calls, or otherwise communicates the code to the customer.

The customer then separately and/or independently accesses the system to direct the system to perform the action by entering the code into the system in association with their specific resource. This second code is compared by the system to the first code already stored associated with the specific resource of the particular customer. When the comparison satisfies the comparison criteria (e.g., the two codes match), the action can be considered to be verified. In some cases, once the particular customer tags the specific resource with a same code as stored by the service vendor, the requested action is automatically initiated.

### BRIEF DESCRIPTION OF THE DRAWINGS

FIG. 1 illustrates an example online services environment in which certain implementations may be carried out.

FIG. 2 illustrates an implementation of a system-enforced two-party verification process in an example online services environment.

FIG. 3A illustrates an example vendor tool interface.

FIG. 3B illustrates an example customer tool interface.

FIG. 4 illustrates a customer support workflow incorporating a system-enforced two-party verification process.

FIGS. 5A and 5B illustrate a customer workflow.

FIGS. 6A and 6B illustrate a service vendor workflow.

FIG. 7 illustrates the online systems process flow.

FIG. 8 shows a block diagram illustrating example details of an online services server that may be used to implement the system enforced two-party verification processes described herein.

### DETAILED DESCRIPTION

Systems and processes are described that enable a software service vendor and customer to mutually verify and act on a customer resource. The described systems and processes can be implemented where a software service vendor and customer are not physically working side-by-side or even acting at the same time. Advantageously, human error rates may be reduced to the probability of a “double failure”—the case where both the vendor support staff and customer make the same mistake.

Organizations, including software companies, frequently elect to have certain services provided by service vendors, who provide a service on behalf of the organization.

In a customer support workflow process where a customer requests the software service vendor to act on the customer's resource, a typical practice today is for software service vendors to request explicit consent from the customers in order to perform an action on the customer's provisioned resources. As two examples, such consent can be requested by email or by an electronic online form. The consent form may indicate the specific customer resources to act on, and even the action being requested, so that the customer may verify the resource (and action). This approach gives customers more opportunities to verify the change that the software service vendor will perform, and also keeps a record of the agreement from customers. However, the consent form approach does not avoid operation errors that may occur should the service vendor “click on” (or otherwise select) the wrong customer or wrong resource to act on.

Shifting the responsibility to the customer to “click” the particular customer and/or specific resource to act on, for example by exposing a feature on a web site to allow the customer to select and act upon his or her own resources (the “self-service” approach), does not necessarily avoid error. The self-service approach removes direct liability of the vendor support staff for failing to act upon the correct resource or for performing the wrong action. However, if a customer makes a mistake, there can still be customer dissatisfaction with the service vendor because the service vendor provided the tools that the customer used (and did not have the appropriate safety measures to help the customer avoid the errors).

In various scenarios described herein, a customer may contact a service vendor to request that one or more of the customer's resources be acted upon. Certain actions may not be available for the customer to directly or independently act upon and, instead, are directed to a support staff. A common action that is directed to a support staff of a service vendor is deprovisioning of a resource. A two-party verification process is presented to facilitate a customer support workflow process that is particularly suitable for high risk actions such as deprovisioning a service subscription or other resource.

Workflow, in the context of customer service support, refers to the assigned steps that customer service representatives are to take when receiving a support request from a customer. Workflow management systems enable the handling and routing of workflow items and related tasks. Customer Relationship Management (CRM) systems can provide workflow management among other capabilities, which may be useful in implementing the system enforced two party verification processes described herein.

In many cases, a workflow item such as a phone call, email, online chat, voice message, or other real-time or non-real time media interaction may act as a trigger or entry point for subsequent work within the workflow. Certain items either discussed with or received by a representative may trigger additional actions either automatically or upon intervention of that representative or another person who creates, consumes, modifies, and/or analyzes data.

The two-party verification process can be carried out for high risk actions such as those that could lead to data loss or service outage if the wrong resource is acted on. The two-party verification process is system enforced such that a system managing a customer's resources facilitates and/or controls the verification process. In some cases, the system enables automatic action upon a resource once the two-party verification process is completed and a successful verification achieved.

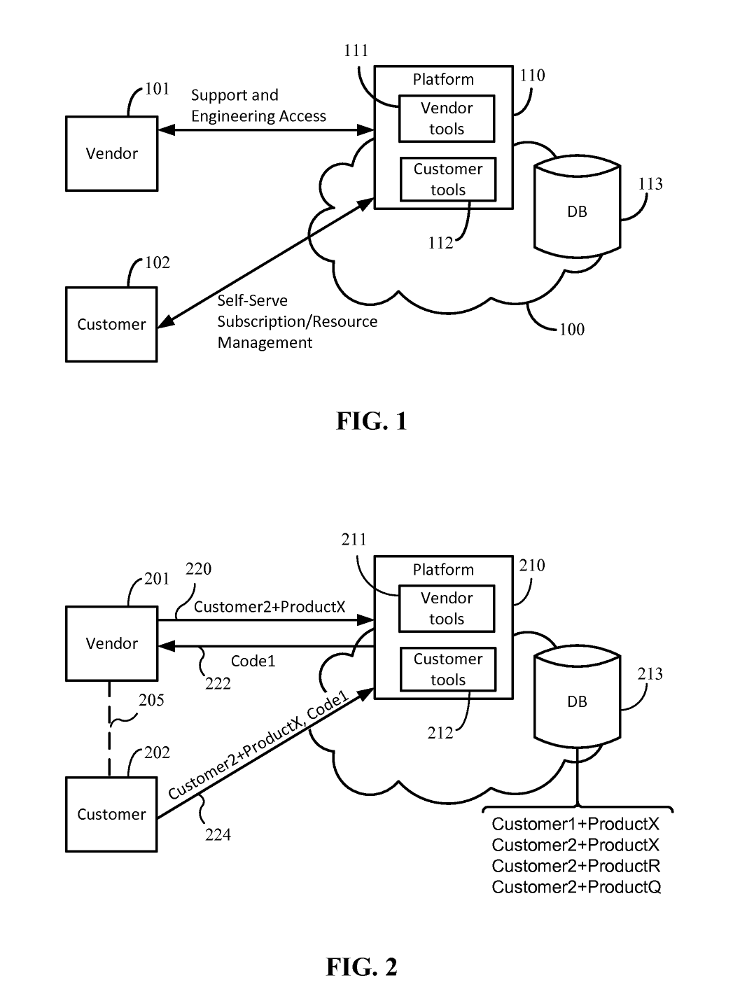

FIG. 1 illustrates an example online services environment in which certain implementations may be carried out. In an online services environment, one or more cloud or web services (“online services 100) may be available from an online service provider. Resources—physical and/or virtual resources, software applications, and other products—can be provided as a service from the online service provider. Example online services include mail and/or messaging services, development software, database management services, collaborative application services and/or productivity application services, as well as various other software-as-a-services, such as Microsoft Exchange®, Microsoft Sharepoint®, Microsoft Office 365®, Google Apps™, and Sales Cloud™ by Salesforce.com.

In some large scale online services, a third party or specified services vendor 101 (which may be separate from or part of the service provider) is used to provide support for the online services. A customer 102 of the online services 100 may contact the services vendor 101 when the customer 102 desires human interaction or help. A platform 110, which may be hosted by the online service provider or used by the online service provider to facilitate the distribution of the online service provider's resources, can include vendor tools 111 and customer tools 112. The vendor tools 111 can provide the tools and engineering access for the vendor 101 to provide support to the customers of the online service. The vendor tools 111 may be available as part of a service vendor management software. The customer tools 112 can provide tools for customers to self-service their subscriptions and perform resource management. In some cases, the customer tools 112 are available for users having administrative rights to a customer account.

A database 113 may also be maintained by the online service provider to manage and track licenses of their customers. A customer may have multiple licenses for various products, and the database 113 can store information of the products provisioned to the customer (and can store user information where multiple users are managed by a single customer).

The cloud or web services, including online services 100 may be implemented using one or more physical and/or virtual servers communicating over a network. The network can include, but is not limited to, a cellular network, a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

The vendor 101 and/or the customer 102 may access the online services 100 via a browser or other application running one or more computing devices including, but not limited to, a personal computer, a tablet, a reader, a mobile device, a personal digital assistant (PDA), a smartphone, a laptop (or notebook or netbook) computer, a gaming device or console, a desktop computer, a smart television, or a wearable computing device (e.g., watch-based, glasses-based). These one or more computing devices can involve computing systems configured with one or more processors, storage media, and I/O devices (e.g., network interface, user input device).

FIG. 2 illustrates an implementation of a two-party verification process in an example online services environment. In an environment such as described with respect to FIG. 1, for example where a third party or specified services vendor 201 is used to provide support for the online services, a customer 202 of the online services may contact the services vendor 201, over any suitable communication channel 205 including, but not limited to, email, messaging and phone, when the customer 202 desires human interaction or help.

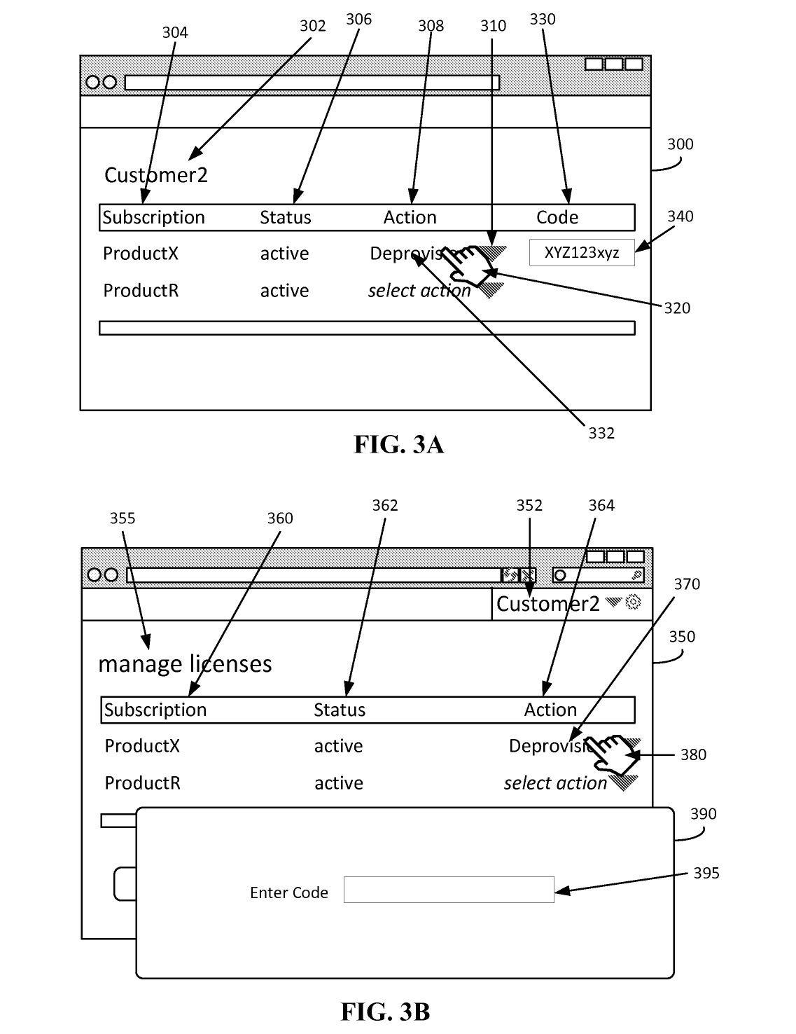

A platform 210, which may be hosted by the online service provider or used by the online service provider to facilitate the distribution of the online service provider's resources, can include vendor tools 211 and customer tools 212. The vendor tools 211 can provide the tools and engineering access for the vendor 201 to provide support to the customers of the online service. FIG. 3A illustrates an example vendor tool interface. The customer tools 212 can provide tools for customers to self-service their subscriptions and perform resource management. FIG. 3B illustrates an example customer tool interface.

A database 213 may also be maintained by the online service provider to manage and track licenses of their customers. The database 213 can include structured information such as customers (by customer identifier) and the products attached to the customer identifier. For example, the database 213 may store information about Customer1 and Customer2. Customer1 may have a license to ProductX while Customer2 has a license to ProductX, ProductR and ProductQ. If Customer2 is the customer 202 that contacts the vendor 201 in order to deprovision ProductX, the vendor 202 may search the database 213 for the customer's account information and, in response to Customer2's request to deprovision Product X via communication 205, can indicate the customer and resource to act upon (220).

When the vendor 201 selects to deprovision ProductX assigned to Customer2, this entry in the database 213 is tagged with a code. In addition, the system can issue a code and provide the code to the vendor (222). The code may be generated by the vendor tools 211 or otherwise obtained by the vendor tools 211 so that a code can be provided to the vendor for informing the customer and stored associated with the resource (and customer). The code may be a string generated, for example, as a unique identifier through any suitable technique known in the art including, but not limited to using random and pseudorandom number generators.

Referring to FIG. 3A, when a service vendor receives a call from a customer, the service vendor may begin a workflow that, at some point, results in determining that the customer desires an action to be taken on an element of the customer's account. In order to perform the action, the vendor may interact with a vendor tool interface 300 to identify the customer's account. For example, the vendor may enter information such as user identifier or customer name in order to have the vendor tool identify the customer and account. As another example, the customer's information automatically surface in the interface based upon metadata or other information found associated with the format of the communication used by the customer to call the vendor (e.g., metadata or tags in an email message, a phone number from which the customer called, a handle of the customer when the customer posts on a social media site, and the like).

In the example illustrated in FIG. 3A, the vendor tool interface 300 may display the customer account 302 (e.g., Customer2). The account information may include subscriptions 304 and status 306. The vendor tool may enable the vendor to indicate an action to be performed on a particular element. For example, available actions 308 may be displayed and selected via a drop down menu 310, input field, or other suitable arrangement. The vendor may select an action for a specific product (320). A code field 330 may be included to display verification codes after the vendor makes a selection. Here, Customer2's ProductX may be selected for deprovisioning 332. In the illustrated example, selecting (320) “deprovision” 332 from menu 310 results in receipt of a code 340. The code 340 can be a string.

Returning to FIG. 2, after the vendor workflow associated with deprovisioning (or performing some other action upon) the resource triggers the sending of a code to the customer, the customer may log-in to their customer tools 212 to confirm the requested action. For example, the customer may sign in to their account, providing their customer identifier, and then indicate the resource to act upon. In addition the code may be entered to validate the request and initiate the action.

Referring to FIG. 3B, a customer may access their account via a customer tool interface 350. While logged into the Customer2 account 352 (e.g., as an administrator), an interface enabling the customer to manage licenses 355 can be accessed. The manage licenses 355 screen may include information regarding the account subscriptions 360, their status 362 and actions 364 that may be taken upon each subscription. Similar to the vendor tool, the actions that may be carried out on a resource can be selected through a menu or other input field. Here, if the customer selects to deprovision 370 ProductX (380), a window 390, a pane, a sidebar or other interface may surface so that the customer may enter a code into an input field 395. The customer inputs the code received from the service vendor (e.g., code 340) into the input field 395.

Although the examples shown in FIGS. 3A and 3B involve a display and a user input device such as a mouse, touch screen and/or keyboard, certain implementations may be carried out over a phone or other audio device.

Since the customer separately logs-in to their account and confirms the action using the code provided by the vendor, if the vendor incorrectly indicated the resource to deprovision, for example, by selecting ProductR instead of ProductX or by selecting ProductX that is associated with Customer1 instead of Customer2, the customer's actions in the two-party verification process can help avoid a mistake. For example, Customer2 may not be able to log on to the account or access the resource information since the code would not match. Similarly, if the customer selects a different product once signed in to the account, then the failure of the codes to match can also inhibit a mistake from occurring. The two-party verification process can also help avoid mistakes where the code is sent to the wrong customer and that customer will not accidently or unintentionally deprovision their own resource or be able to affect the correct customer's resources (since the code is associated with a customer's account as well as the resource).

Because the system verifies actions by having both the service vendor and the customer tag a system resource with a same code, where the code is system generated and communicated from the service vendor to the customer outside of the system, it is possible to verify the customer and resource to act on from both parties—even where the parties are remote and operating at different times.

Furthermore, the action on the resource may be triggered automatically upon successful code based verification, to avoid human errors in the time between the verification and the action on the resource.

The following examples are illustrative of some of the methods, applications, embodiments and variants of the present invention. They are, of course, not to be considered in any way limitative of the invention. Numerous changes and modifications can be made with respect to the invention.

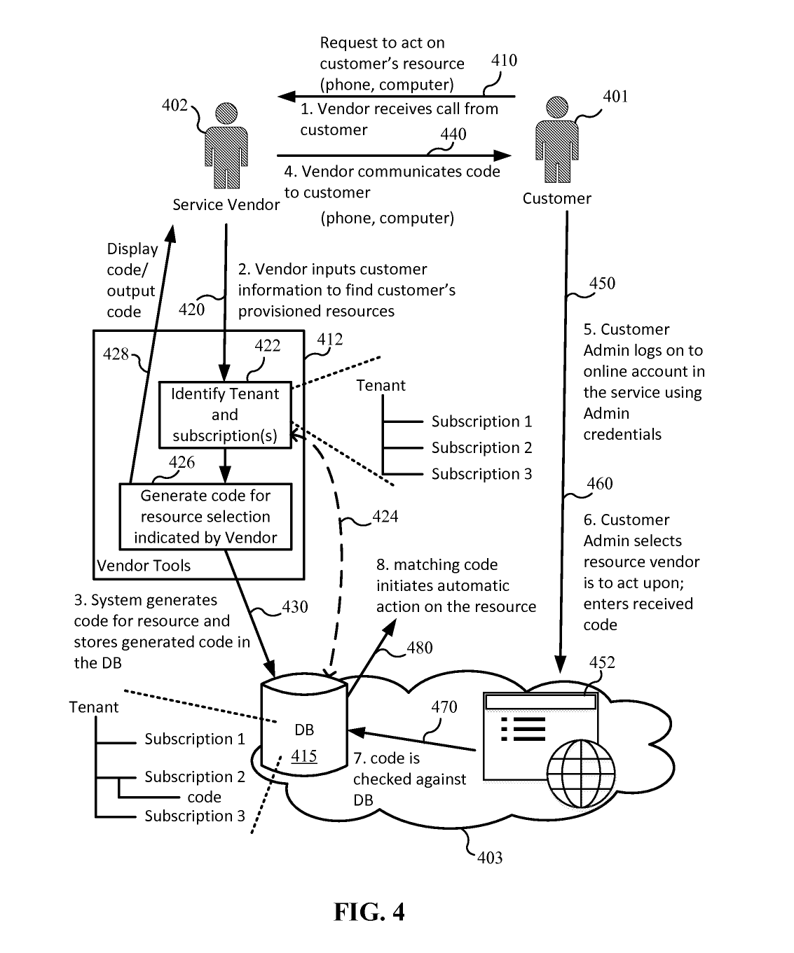

FIG. 4 illustrates a customer support workflow incorporating a system-enforced two-party verification process. A customer support workflow can involve a customer 401 and a service vendor 402 communicating in response to an issue or request that the customer 401 may have with respect to online services 403.

In step 1, the service vendor 402 receives a call from the customer 403 to act on the customer's resource (410). The customer 403 may communicate a request to the service vender 402 by phone, text, email, website form, online chat window, or even social media (e.g., TWITTER, FACEBOOK), as some examples. The request to act on the customer's resource may be to deprovision an unused subscription.

It should be understood that more than one person may be involved at the vendor 402 and that the person handling the call may be different than the person receiving the call. In addition, there may be multiple layers of support and various levels handling different issues—each with their own or overlapping workflows. The vendor 402 and the customer 401 may also not be communicating in real-time.

In step 2, the service vendor 402 can open a tool 415 that helps the vendor support the online services. The tool 412 may be available through a portal to the online services 403. In some cases, the tool 412 can be a local application on the vendor's device that communicates with the online services such as online services database 415 containing information related to customer/tenants and their associated subscriptions. The vendor 402 can use the tool 412 to find the customer's provisioned resources and the specific one to act on based on the information provided by the customer 401. For example, with information from the customer 401 such as name and/or user identifier, the vendor tools 412 can identify tenant and subscriptions (422), for example, by retrieving the information from the database 415 (424). From within the vendor tools 412, the service vendor 402 can select the specific element (e.g., subscription) that the customer 401 would like particular action taken upon (see e.g., FIG. 3A).

In step 3, in response to the service vendor clicking on or otherwise indicating selection of a specific customer resource to act on, a code is generated and then stored in the database 415. The code may be generated locally at the service vendor device or the code may be generated by a code generator component that is part of the online services 403. The code, once generated, is provided to the service vendor 402 (428) and stored in the database 415 in a manner that the code is associated with the resource to act on (430).

For example, the customer 401 may have provided information to the service vendor 402 that led the service vendor 402 to believe that the customer 401 would like to have “subscription2” deprovisioned. Then, when the vendor 402 selected subscription2 from the customer's identified resources, the code that is generated can be stored in the database 415 and associated with subscription2. The code may encode information about the element and/or the action to be performed or the code can be stored as part of a structured database in which the code used in the verification process and the action to be taken upon the resource (which may be in the form of a code or program call or word or phrase) are stored in connection with the subscription (or other element to be acted upon).

In step 4, the code output to the service vendor (428) can be communicated by the service vendor 402 to the customer 401 (440). The vendor 402 may communicate this code via any suitable communication method including, but not limited to, phone, email, and messaging.

In step 5, the customer 401 can log on to the customer's online account (450), for example via a web portal 452. The person logging in for the customer 401 may be the same person or a different person than who contacted the service vendor 402. In some cases, the customer 401 may log in to the online account in the service under an administrator credential. The administrator credential can provide additional functionality or rights in the service. An administrator is generally a designated individual (or individuals) responsible for maintaining a multi-user computing system. The administrator is often involved in assigning and handling resources and privileges for other users.

In step 6, the customer 401, while in the online account, may select the resource that the customer wishes the software vendor to act on. A user interface may be provided where, when the administrator logs in, a workflow initiates to facilitate the customer in confirming the request to act upon a resource. For example, an input field can surface in which the customer enters a code (see e.g., FIG. 3B).

In step 7, the system can compare (470) the code entered by the customer and the code that was generated and stored in the database 415 in step 3. If the comparison satisfies the comparison criteria, for example by matching or by some other criteria, then the software system automatically acts on the resource on the software vendor's behalf (480).

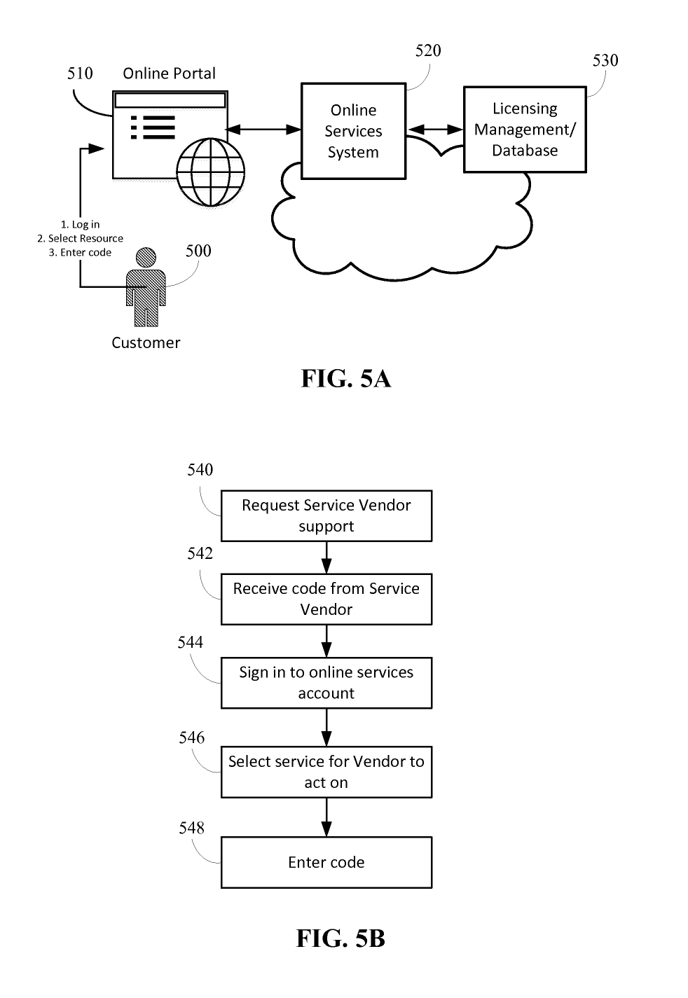

FIGS. 5A and 5B illustrate a customer workflow. Referring to FIG. 5A, a customer 500 may log in, select a resource and enter a code via an online portal 510 to an online services system 520, and more particularly to a licensing management system 530. That is, a customer may request service vendor support (540), receive code from a service vendor (542), sign in to their online services account (544), select the service for the vendor to act on (546) and enter code (548).

The code is not automated to the customer. Rather, the code is provided to the service vendor who responds to the customer's request.

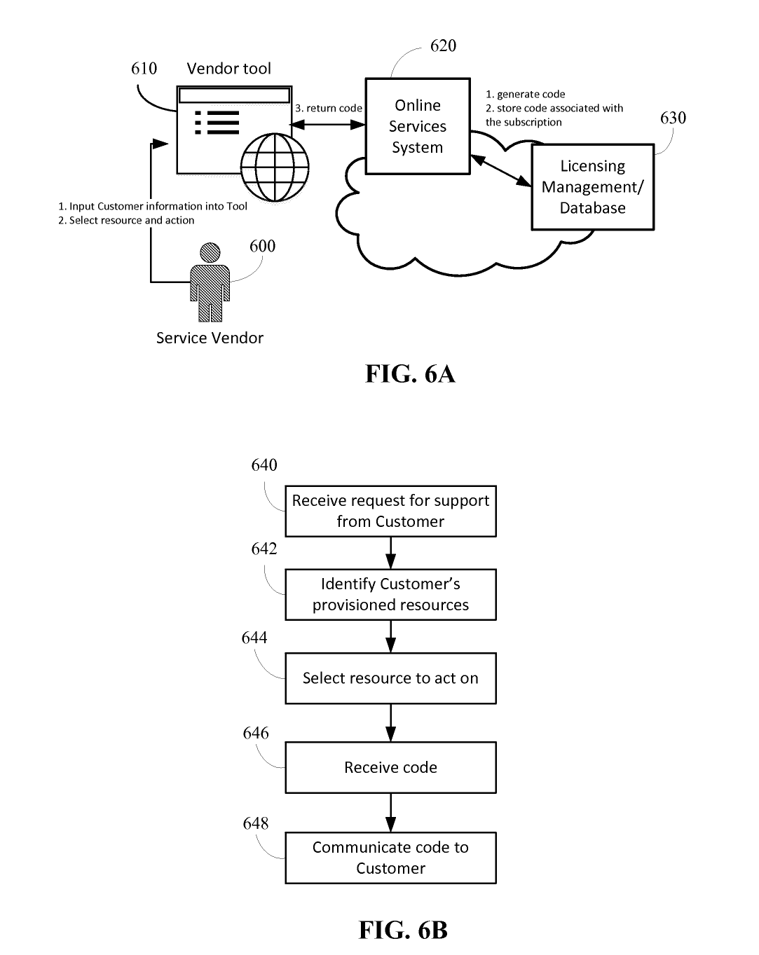

FIGS. 6A and 6B illustrate a service vendor workflow. Referring to FIG. 6A, a service vendor 600 may input customer information and select a specific resource to take action upon within a support service tool 610 to an online services system 620. The online services system 620 can generate a code and store the code associated with the customer resource in a licensing management system 630. The code can be returned to the service vendor 600 and output via the support service tool 610. That is, a service vendor may receive a request for support from a customer (640), identify the customer's provisioned resources (642), select a resource to act on (644), receive a code (646) and communicate the code to the customer (648). Action is not taken until after the customer logs in to their account and enters the code.

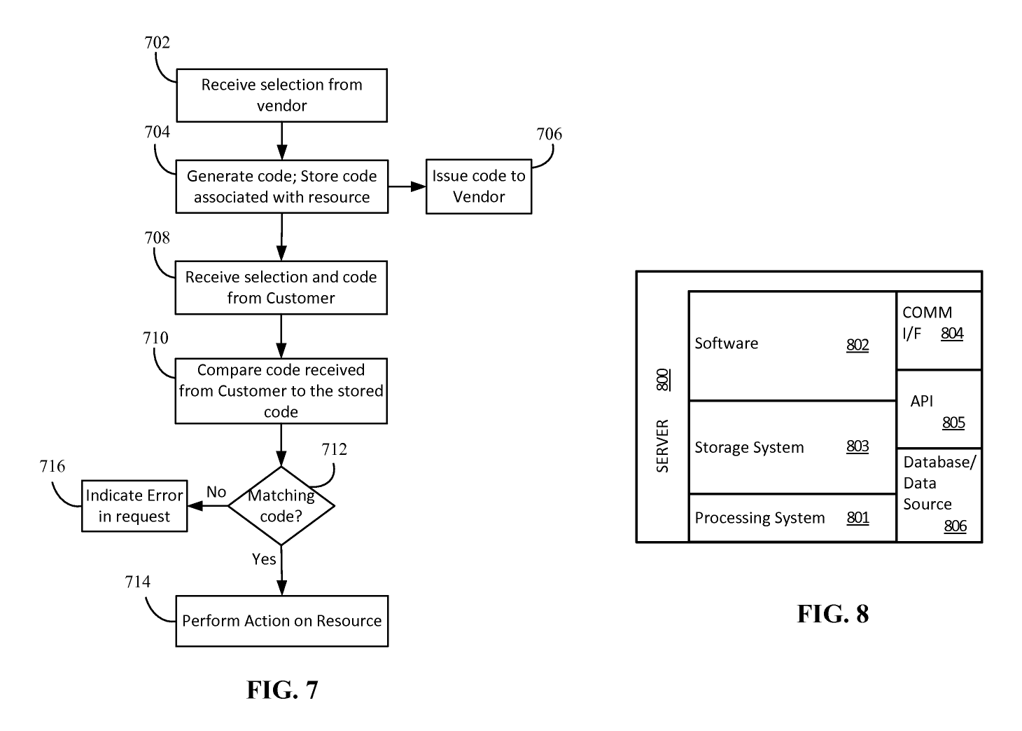

FIG. 7 illustrates the online systems process flow. In operation 702, the system may receive a selection from a vendor. The system can generate a code and store the code associated with a resource (704), as well as issue the code to the vendor (706). As previously mentioned, the code is not automated to the customer. Rather, the code is provided to the service vendor who responds to the customer's request. At some point in time, the system receives a selection and code from the customer (708). The code received from the customer is compared to the stored code (710). If the code matches, the action is performed on the resource (714). If the code does not match (712), an error with the request may be indicated (716).

The system may further include certain measures to provide additional layers of protection, which are useful for critical customer resources. For example, a time limit may be associated with the code. The time limit may be based on the date and time that the service vendor initiated the process to issue the first code (the stored code). Then, if a customer fails to enter the second code (which would be received from the customer) within the time limit, the code can be invalidated and the customer will need to contact the service vendor again to start the process for performing the action.

Another layer of protection that may be included is a delay from initiating the requested action (or from the time that the comparison of the code received from the customer and the stored code satisfies the comparison criteria) to enable reversing of certain requested actions. This delay can be considered a lock state, where a resource may not be acted upon by a customer but is not immediately deleted by the system. The lock state can lock out the customer so the customer's access to the resource is terminated, but if the deletion is determined to be in error (or the customer changes their mind or needs more time with the resource), the resource can be more easily recovered during the lock state delay. In the case where the customer recognizes that the resource is needed within the delay for the lock state (e.g., a certain number of days), the customer may contact the service vendor to recover the resource and the service vendor can revert the state of the resource from the lock state to an active state. After the certain number of days, the system can automatically delete the resource after which recovery may not be possible.

FIG. 8 shows a block diagram illustrating example details of an online services server that may be used to implement the system enforced two-party verification processes described herein. The server 800 may include one or more computing devices. For example, the server 800 can include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The server 800 can include a processing system 801, which may include a processing device such as a central processing unit (CPU) or microprocessor and other circuitry that retrieves and executes software 802 from storage system 803. Processing system 801 may be implemented within a single processing device but may also be distributed across multiple processing devices or sub-systems that cooperate in executing program instructions.

Examples of processing system 801 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 803 may comprise any computer readable storage media readable by processing system 801 and capable of storing software 802. Storage system 803 may include volatile and nonvolatile, removable and non-removable media implemented in any method or technology for storage of information, such as computer readable instructions, data structures, program modules, or other data.

Examples of storage media include random access memory (RAM, DRAM, SRAM), read only memory (ROM, PROM, EPROM, EEPROM), magnetic disks, optical disks, CDs, DVDs, flash memory, magnetic cassettes, magnetic tape, magnetic disk storage or other magnetic and ferromagnetic/ferroelectric storage devices, or any other suitable storage media. Certain implementations may involve either or both virtual memory and non-virtual memory. In no case is the storage media a propagated signal.

In addition to storage media, in some implementations storage system 803 may also include communication media over which software 802 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 801.

Software 802 may be implemented in program instructions and among other functions may, when executed by server 800 in general or processing system 801 in particular, direct server 800 or processing system 801 to operate as described herein for system enforced two-party verification. Software 802 may include additional processes, programs, or components, such as operating system software or other application software. Software 802 may also comprise firmware or some other form of machine-readable processing instructions executable by processing system 801.

In general, software 802 may, when loaded into processing system 801 and executed, transform server 800 overall from a general-purpose computing system into a special-purpose computing system customized to facilitate the system enforced two-party verification as described herein for each implementation. Indeed, encoding software 802 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage.

Server 800 may represent any computing system on which software 802 may be staged and from where software 802 may be distributed, transported, downloaded, or otherwise provided to yet another computing system for deployment and execution, or yet additional distribution.

It should be noted that many elements of server 800 may be included in a system-on-a-chip (SoC) device. These elements may include, but are not limited to, the processing system 801, a communications interface 804, and even elements of the storage system 803 and software 802.

In embodiments where the server 800 includes multiple computing devices, the server can include one or more communications networks that facilitate communication among the computing devices.

For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 804 may be included, providing communication connections and devices that allow for communication between server 800 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

The server 800 may also include an API server 805 and even a database (or data source) 806. The API server 805 may be implemented in various ways. For example, the API server 805 can be implemented as application software, utility software, or another type of software executed by one or more processing units of computing devices or processing system 801 in the server system 800. Furthermore, in some embodiments, the API server 805 can be implemented using one or more application-specific integrated circuits (ASICs).

The API server 805 can be used to expose functionality available by the online services server(s), including vendor tools and customer tools. The database (or data source) 806 can store customer information (including subscriptions) and associated verification codes. The API server 805 may be a separate computing device from the server 800 or represent an API service of the server 800 that enables user devices or other servers to invoke methods in the API.

It should be understood that the examples and embodiments described herein are for illustrative purposes only and that various modifications or changes in light thereof will be suggested to persons skilled in the art and are to be included within the spirit and purview of this application.

What is claimed is:

1. A method of two-party verification for performing an action associated with an element of an account, comprising:
issuing a first code to a first party who is separately communicating with a second party associated with the account, wherein the first code is generated in response to receiving an indication from the first party to perform the action associated with the element of the account and is associated with at least the element of the account;
receiving an indication and a second code from the second party associated with the account to perform the action associated with the element of the account;
comparing the second code received from the second party associated with the account to the first code issued to the first party to determine whether or not a comparison of the first code and the second code satisfies comparison criteria; and
enabling the action associated with the element of the account to be performed when the comparison of the first code and the second code satisfies the comparison criteria.

2. The method of claim 1, wherein enabling the action associated with the element of the account to be performed comprises enabling the first party to perform the action.

3. The method of claim 1, further comprising automatically performing the action upon the enabling of the action.

4. The method of claim 1, wherein the first code is further associated with an indication of the action to be performed.

5. The method of claim 1, wherein the first code is associated with at least the element of the account by storing the first code in an account management database in which the element and the account are stored.

6. The method of claim 1, wherein the first code is associated with at least the element of the account by storing the first code in a table associated with the account.

7. The method of claim 1, wherein the first code is a string.

8. The method of claim 1, wherein the action is deprovisioning and the element is a subscription.

9. The method of claim 1, wherein the first party is a service vendor.

10. The method of claim 1, wherein the indication and the code comes from within an administrator credentialed instance of the second party of the account.

11. An online service support system comprising:
a management system including one or more processors, storage media storing management software and a database at least identifying resources comprising user subscriptions of online services managed by the management software;
a support tool associated with the management software providing a support service workflow from which actions may be performed on the database; and
a customer tool associated with the management software providing customers administrative access to their customer accounts,
wherein the management software, when executed by the one or more processors of the management system, directs a first code to be issued upon receipt of a selection of a particular customer, a specific resource and an action to be taken on the specific resource via the support tool.

12. The online service support system of claim 11, wherein the management software, when executed by the one or more processors of the management system, further directs the management system to:
store the first code in the database associated with the particular customer and the specific resource.

13. The online service support system of claim 12, wherein the management software, when executed by the one or more processors of the management system, further directs the management system to:
store an indication of the action to be taken in the database associated with the particular customer and the specific resource.

14. The online service support system of claim 11, wherein the management software, when executed by one or more processors of the management system, directs the management system to:
compare, upon receipt of a second code via the customer tool, the first code with the second code to determine whether or not a comparison of the first code and the second code satisfies comparison criteria; and
enable the when the comparison of the first code and the second code satisfies the comparison criteria.

15. The online service support system of claim 11, wherein the management software, when executed by one or more processors of the management system, directs the management system to:
compare, upon receipt of a second code via the customer tool, the first code with the second code to determine whether or not a comparison of the first code and the second code satisfies comparison criteria; and
automatically perform the action when the comparison of the first code and the second code satisfies the comparison criteria.

16. A system-enforced two party verification process, comprising:
verifying that a specific resource belonging to a particular customer and managed by an online services system is to be acted upon by requiring a service vendor and the particular customer to tag the specific resource with a same code, wherein the code is generated by the online services system and provided to the service vendor for the service vendor to separately communicate the code to the customer.

17. The system-enforced two party verification process of claim 16, wherein the service vendor communicates the code to the customer by a different communication channel than the one over which the code is provided to the service vendor.

18. The system-enforced two party verification process of claim 16, wherein a successful verification occurs when the online services system determines that the specific resource is tagged with the same code by both the service vendor and the particular customer.

19. The system-enforced two party verification process of claim 18, further comprising:
automatically triggering a change to the specific resource upon the successful verification.

20. The system-enforced two party verification process of claim 19, wherein the change comprises deprovisioning of the specific resource.
